(19) United States
(12) Patent Application Publication
(10) Pub. No.: US 2013/0156878 A1
(43) Pub. Date: Jun. 20, 2013

(54) MICROSTRUCTURE TRANSCRIPTION APPARATUS

(71) Applicant: Hitachi High-Technologies Corporation, Tokyo (JP)

(72) Inventors: Toshimitsu SHIRAISHI, Saitama (JP); Naoaki YAMASHITA, Saitama (JP); Noritake SHIZAWA, Saitama (JP); Tsutomu NAGAKURA, Saitama (JP)

(73) Assignee: HITACHI HIGH-TECHNOLOGIES CORPORATION, Tokyo (JP)

(21) Appl. No.: 13/689,803

(22) Filed: Nov. 30, 2012

(30) Foreign Application Priority Data
Dec. 2, 2011 (JP) 2011-264163

(51) Int. Cl. B29C 59/02

(52) U.S. Cl. CPC B29C 59/022
USPC 425/385

(57) ABSTRACT

A microstructure transcription apparatus for transcribing microscopic concave-convex patterns on a body to be transcribed includes a stamper, on a surface of which is formed microscopic concave-convex pattern; and a stamper holder portion, which holds the stamper. The stamper holder portion includes a transparent backup member, a stamper backup elastic body attached on the backup portion covering over a central portion thereof, a space, into which a negative pressure is introduced for absorbing said stamper to hold, and a member, which is formed surrounding said stamper holder portion therein and contacts on an outer peripheral portion of said stamper. The contact member is movable with respect to the backup member, and thereby a curvature of a curved surface of said stamper to be suppressed onto said stamper backup elastic body is changeable, enabling to alter a curvature of a spherical shape on the surface of the stamper when transcribing.

### BACKGROUND OF THE INVENTION

The present invention relates to a microstructure transcription apparatus for transcribing ultrafine structures formed on a stamper on a surface of a body to be transcribed.

In recent years, micronization (or miniaturization) and integration are advanced further, for semiconductor circuits, and as a pattern transcribing technology for achieving such micromachining of those, an improvement is made on a photolithography apparatus, in particular, high-precision thereof. However, the exposure light comes close to the wavelength of a light source in the machining method; i.e., the photolithography gets closer to the limit thereof. For that reason, for advancing the micronization and the high-precision further is applied an electron-beam lithography system or apparatus, a kind of an apparatus of charged particle beam, in the place of the lithography technology.

Since a pattern forming with use of an electron beam adapts a method of drawing a mask pattern, differing from a block exposure method in the pattern forming with use of a light source, such as, an “i” beam, an excimer laser, etc., it takes a time for exposure (i.e., drawing) longer if a number of patterns to be drawn is larger; it is said to have a drawback of taking a long time for the patter forming. For that reason, accompanying with a tremendous increase of the integration, such as, 256 megabyte, 1 gigabyte, 4 gigabytes, for example, the time necessary for pattern forming time comes to be long for that, tremendously, and there is a concern that throughput comes down, remarkably. Then, for achieving high-speed of the electron-beam lithography apparatus, a development is made on a block pattern irradiation method for forming electron beams having a complicated form by irradiating the electron beams in the block thereon, while combining various kinds of masks. As a result of this, advancement is made on the micronization of patterns; however on the other hand, there are drawbacks, such as, there is necessity of a mechanism for controlling the mask position at higher accuracy, etc., other than that the electron-beam lithography apparatus must be large in the sizes thereof; i.e., increasing costs of the apparatus.

On the contrary to this, there is an in-print technology for conducting the miniature pattern forming with a low cost. This is a technology of stamping a stamper, having concavo-convex of a patter same to that to be formed on a substrate, onto a resist film layer, which is formed on a surface of the substrate to be transcribed, and then exfoliates the stamper, thereby transcribing a predetermined pattern on the resist, wherein a silicon wafer is used as the stamper for enabling to form the microstructure equal to or less than 25 nanometers through the transcription. And, studies have been made upon an application of the in-print technology, for forming recording bits of a large capacity recording medium, forming of semiconductor integrated circuit patterns, etc.

In such in-print technology, for transcribing the micro patterns on the substrate of the large capacity recording medium or the substrate of the semiconductor integrated circuits, with high accuracy or precision, there is necessity of suppressing the stamper thereon, so that pressure is applied within a pattern transcribing region, uniformly, on the surface of the substrate to be transcribed, on which micro surging is generated. And, when transcribing, it is also necessary to change a curvature of a spherical shape on the surface of the stamper, fitting to the condition suitable for a material of the body to be transcribed, or fitting to the size of the body to be transcribed.

In the following Patent Document 1 is described an invention relating to a technology to prevent air bubbles from intrusion there, due to the micro surging on the surface, with conducting the transcription while generating deflection on a master, in the method for manufacturing an optical disc.

Also, in the following Patent Documents 2 and 3 is described an invention relating to a technology to prevent the air bubbles from instruction thereof, due to the micro surging on the surface, with conducting the transcription while suppressing the stamper by a fluid to be curved.

Further, in the following Patent Document 4 is described an invention relating to a technology to prevent the air bubbles from intruding thereof, due to the micro surging on the surface, by conducting the transcription within a vacuum or within a liquefied gas, and thereby conducting a uniform pattern transcription, in the technology for transcribing the micro patterns through a nano-in-print.

### PRIOR ART DOCUMENTS

### Patent Documents

[Patent Document 1] Japanese Patent Laying-Open No. 2004-303385 (2004);

[Patent Document 2] Japanese Patent Laying-Open No. 2008-230027 (2008);

[Patent Document 3] Japanese Patent Laying-Open No. 2006-018975 (2006); and

[Patent Document 4] Japanese Patent Laying-Open No. 2009-220559 (2009).

### BRIEF SUMMARY OF THE INVENTION

However, the transcription method described in the Patent Document 1 mentioned above relates to a mechanical fixing method, wherein no consideration is paid on an ill influence due to generation of dusts in a sliding portion in contact with the stamper. Also, of course on an aspect of generating an unevenness in the extension of wetting of the resist because of difficulty in deforming a minute amount continuously, no consideration is paid on changing the curvature of the spherical shape on the surface of the stamper fitting to the condition suitable for the material of the body to be transcribed, or fitting to the size of the body to be transcribed, when transcribing.

On the other hand, in accordance with the transcription method described in the Patent Documents 2 and 3 mentioned above, although generation of the air bubbles due to micro surging on the surface can be suppressed, but there are problems that the dust generation generated due to leakage of the fluid lowers a degree of purity of an environment, and that it makes the structure thereof complicated, and no consideration is paid on the structure for alternating the curvature of the spherical shape on the surface of the sample when transcribing.

Further, with the method described in the Patent Document 4 mentioned above, although the intrusion of air babbles due to the micro surging on the surface can be prevented, however since the entire must be within a vacuum tank, there are problems that the apparatus must be large in the sizes thereof, and that a throughput of the entire is lowered down since taking out and putting in the vacuum tank takes a time. In addition thereto, no consideration is paid on the alternation of the curvature of the spherical shape on the surface of the sample when transcribing.

Then, an object of the present invention, accomplished for dissolving the problems of the prior arts mentioned above, is to a microstructure transcription apparatus for enabling to change a curvature of a spherical shape on the surface of a stamer, appropriately, when transcribing.

For accomplishing the object mentioned above, according to the present invention, there is provided a microstructure transcription apparatus for transcribing microscopic concave-convex patterns on a body to be transcribed, comprising: a stamper, on a surface of which is formed microscopic concave-convex pattern; and a stamper holder portion, which holds said stamper, wherein said stamper holder portion comprises a transparent backup member, a stamper backup elastic body, which is attached on said backup portion covering over a central portion thereof, a space, into which a negative pressure is introduced for absorbing said stamper to hold, and a member, which is formed surrounding said stamper holder portion therein and contacts on an outer peripheral portion of said stamper, and further said contact member is movable with respect to said backup member, and thereby a curvature of a curved surface of said stamper to be suppressed onto said stamper backup elastic body is changeable.

Also, according to the present invention, in the microstructure transcription apparatus, as described in the above, preferably, said contact member is movable through pressure, with respect to said backup member, and further, said contact member is disposed in a space within an inside of a circular frame member, being formed surrounding said stamper holder portion, in a movable manner, and further comprises a means for introducing pressure into the space defined between said frame member and said contact member.

According to the present invention mentioned above, there can be obtained an effect of enabling to alter or change the curvature of the spherical shape on the surface of the stamper, appropriately, fitting to the condition suitable for the material of the body to be transcribed or for the size thereof, most suitably, when conducting the transcription, and thereby to provide the microstructure transcription apparatus for enabling transcription of micro patterns, without lowering the throughput of an entire, in spite of changing of a model to be manufactured.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a perspective view, including a partial cross-section view thereof, for showing the entire configuration of a microstructure transcription apparatus, according to an embodiment of the present invention;

FIG. 2 is a block diagram for showing the microstructure transcription apparatus mentioned above, also including peripheral equipment thereof;

FIG. 3 is a flowchart for explaining an operation of transcribing the micro patterns within the microstructure transcription apparatus mentioned above;

FIGS. 4A-4E are views for showing transition of condition, such as, pressure within the microstructure transcription apparatus, when it operates to transcribe the micro patterns mentioned above; and

FIG. 5 is a view for showing a curving condition of a stamper within the microstructure transcription apparatus mentioned above.

### DETAILED DESCRIPTION OF THE PREFERRED EMBODIMENTS

Hereinafter, detailed explanation will be made about a microstructure transcription apparatus, according to an embodiment of the present invention, by referring to drawings attached herewith.

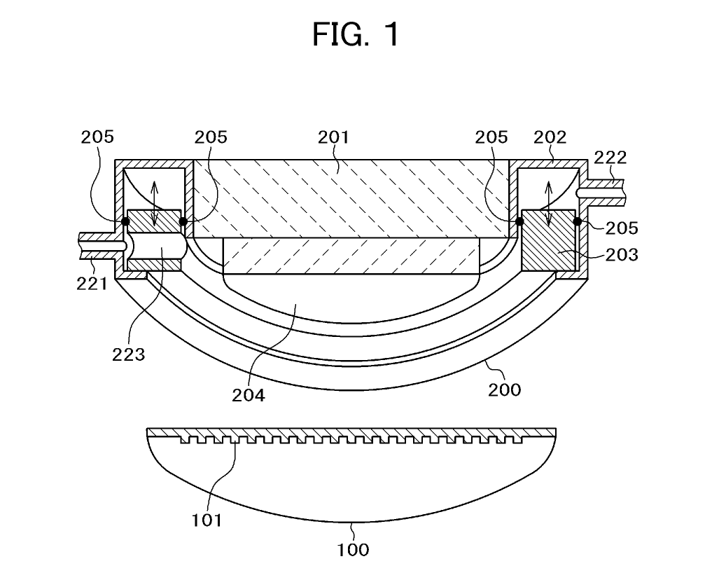

In FIG. 1 is shown the structure of the microstructure transcription apparatus, according to the embodiment of the present invention. That apparatus is, as is shown in the figure, mainly built up with a stamper 100 like a thin disc, and a stamper holder portion 200 having a cylindrical outer shape, for supporting (i.e., vacuum holding) that stamper, with absorbing the lower surface thereof.

Further, the stamper 100 mentioned above has a transcription portion 101 for transcribing microscopic concave-convex patterns on a surface thereof (i.e., a lower surface in the figure), and that surface is pressed on a surface of a body to be transcribed, such as, a disc substrate, etc., for example, after applying a resist thereon by a printing apparatus not shown in the figure; thereby forming the microscopic concave-convex patterns.

Also, in the stamper holder portion 200 comprises a backup member 201, at a central portion thereof, being made of a transparent material, such as, a crystal and a glass, etc., for example, a circular frame member 202 being provided surrounding a periphery thereof, defining a space in an inside thereof, a ring-like member 203, being inserted/disposed to be movable within the internal space of that frame member 202 (in a direction of an arrow shown in the figure), and a stamper backup elastic body 204, which is attached at a central portion of the surface (i.e., the lower surface in the figure) of the stamper holder portion 200. Further, this stamper backup elastic body 204 is smaller than the backup member 201 mentioned above, in a diameter thereof (i.e., forming a circular space between the circular frame member 202), and is made of a member, being softer than that (i.e., being high in the elastic modulus), for example, a transparent elastic member, such as, a silicon rubber, etc. Also, the ring-like member 203 is so constructed/disposed that it contacts on an outer periphery portion of the stamper 100, upon the reverse surface thereof.

On the other hand, the frame member 202 is made of a metal, such as, iron, etc., for example, and in a part thereof (e.g., an outer peripheral surface, in the present example) are formed pressure introduction ducts 221 and 222 for introducing a desired pressure into plural numbers of spaces (e.g., two (2) spaces in the present example), which are formed within an inside of the stamper holder portion 200. Also, in a part of the ring-like member 203 mentioned above is formed a penetrating hole 223 for use of pressure introduction, at a position approximately fitting to one of the pressure introduction duct 221. Thus, the pressure of the pressure introduction duct 221 is guided into the circular space, which is defined between the circular frame member 202 and the backup elastic body 204 mentioned above. On the other hand, the pressure of the pressure introduction duct 222 is guided into the space, which is defined between the circular frame member 202 and the ring-like member 203 mentioned above. Also, a reference numeral 205 in the figure depicts so-called, “O” rings for sealing, which are provided on an outer periphery and an inner periphery of the ring-like member 203 mentioned above, and with this, it is possible to keep the space defined between the frame member 202 and the ring-like member 203 to be airtight with respect to an outside, in spite of movement of the ring-like member 203 within that circular frame member 202.

Thus, with such stamper holder portion 200, the detailed structures thereof being mentioned in the above, brining the circular space, being defined between the circular frame member 202 and the backup elastic member 204, into a negative pressure enables to fix/hold the disc-like stamper 100 on the lower surface thereof. Also, guiding a pressure (i.e., a positive pressure or a negative pressure) into the space, being defined between the frame member 202 and the ring-like member 203 mentioned above, enabling to move the ring-like member 203 into the direction of an arrow shown in the figure. Although will be explained in more details thereof later, this builds up a mechanism for changing or altering the surface of the stamper 100 mentioned above into a spherical shape having a desired curvature.

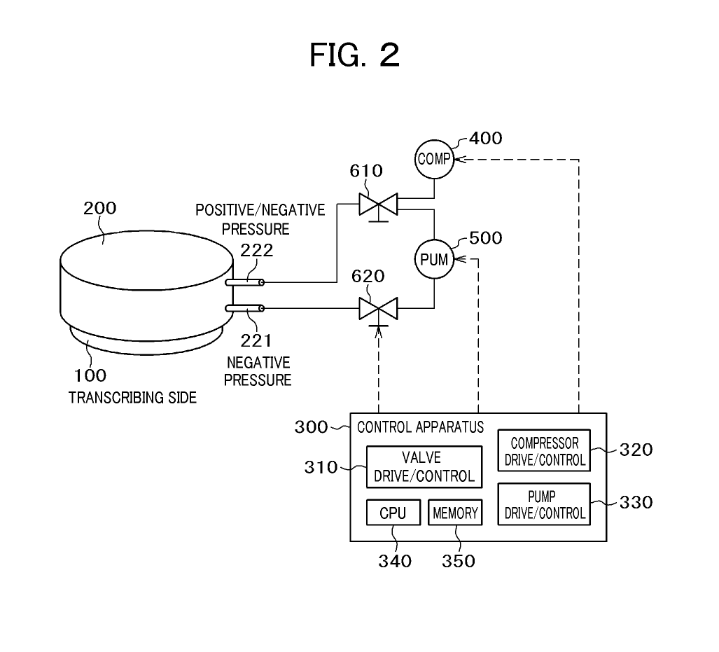

Next, FIG. 2 attached herewith is a block diagram for showing the stamper 100, the detailed structures of which are mentioned in the above, and the stamper holder portion 200 for holding/fixing it, including a control apparatus 300 for supplying/controlling a desired pressure to the stamper holder portion 200. In the figure, a reference numeral 400 depicts a compressor for generating a positive pressure, while 500 a pump for generating a negative pressure. Either one of those pressures from the compressor 400 and the pump 500 is selectively guided to a pressure introduction duct 222 of the stamper holder portion 200 mentioned above, via a control valve 610, and further the pressure (e.g., the negative pressure) from the pump 500 is guided to a pressure introduction duct 221, via another control valve 620. However, herein, although the compressor and the pump are shown as the means for generating the positive pressure and the negative pressure, respectively, as an example thereof; however, the present invention should not be limited to those, and other than those, for example, an accumulator maybe applied as the negative pressure source or the positive pressure source.

On the other hand, the control apparatus 300 comprises those compressor 400 and vacuum pump 500, and further driver/controller portions (in more details, a valve driver/controller portion 310, a compressor driver/controller portion 320, and a pump driver/controller portion 330) for driving/controlling the control valves 610 and 620, as well as, a central processor unit (CPU) 340 for conducting calculating processes for those controls and a memory device (e.g., a memory) 350 for that.

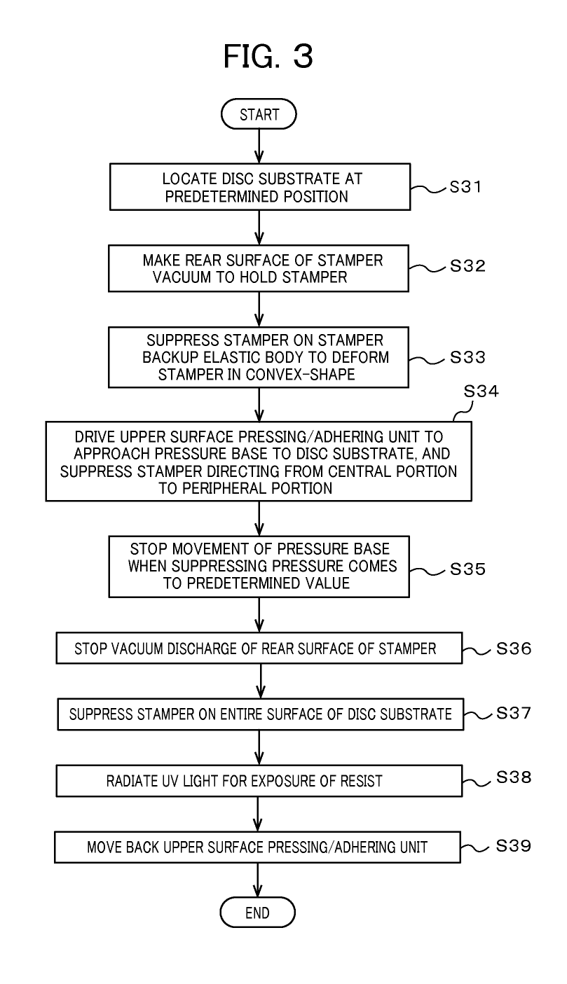

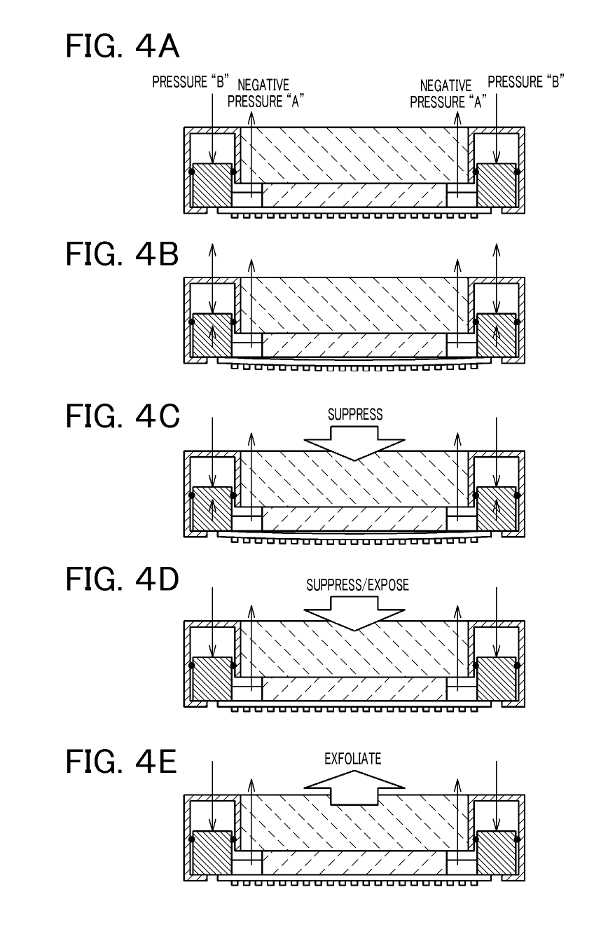

Following to the above, explanation will be made on the operation when transcription is made by the microstructure transcription apparatus mentioned above, by referring to FIG. 3 and FIGS. 4A-4E attached herewith. However, the operation, which will be shown below, is executed by the CPU 340 upon basis of a program, which is stored in advance, into the memory 350 shown in FIG. 2.

By referring to the flowchart shown in FIG. 3, first of all, a disc substrate (not shown in the figure) before transcription, being applied with the resist thereon, is disposes at a predetermined position of the apparatus (step S31). Further, as a method for this application may be used, for example, a spin coating or an inkjet, etc.

Next, while applying the negative pressure on a rear surface of the stamper 100, i.e., guiding the negative pressure (i.e., a negative pressure “A”) generated by the pump 500 mentioned above into the circular space, which is defined between the frame member 202 of the stamper holder portion 200 and the backup elastic body 204, the stamper 100 is held (step S32). The condition of the pressure, etc., within the microstructure transcription apparatus, in this instance, are shown in FIG. 4A attached. However, in this instance, although the ring-like member 203 turns back to a predetermined position (i.e., the lowest position in the figure) due to the weight of itself (i.e., the empty weight); however depending on cases, that ring-like member 203 may be turned back to the lowest position by introducing the pressure (i.e., the positive pressure) into the space, which is defined between the circular frame member 202 and the ring-like member 203.

Following to the above, under the condition mentioned above, that stamper is deformed (step S33), by controlling the negative pressure (i.e., the negative pressure “A”) guided into the space defined between the frame member 202 and the backup elastic body 204, in other words, by pressing the stamper 100 to the stamper backup elastic body 204. Thus, with doing this, the surface of the stamper 100 is curved into a spherical shape. In this instance, further, if controlling the pressure (i.e., the positive pressure of the negative pressure), appropriately, to be guided into the space defined between the circular frame member 202 and the ring-like member 203, it is possible to change the position of the ring-like member 203 contacting on the periphery portion of the stamper 100 (into the upward/downward direction in the figure), and thereby it is possible to alter the curvature of the spherical shape on the surface of the stamper 100, appropriately. Further, the condition of the pressure, etc., within the microstructure transcription apparatus, in this instance, are shown in FIG. 4B attached.

In more details thereof, a necessary curvature is obtained, in advance, fitting to the condition suitable for the material of the body to be transcribed or for the size thereof, and the negative pressure (value) “A” necessary for obtaining that curvature, and further the positive pressure (value) “B” necessary for, as well, and those are stored into the memory 350, in advance. And, those may be read out from the memory depending on the necessity, so as to control the compressor 400 and the pump 500 mentioned above, as well as, the control valves 610 and 620, upon basis of those.

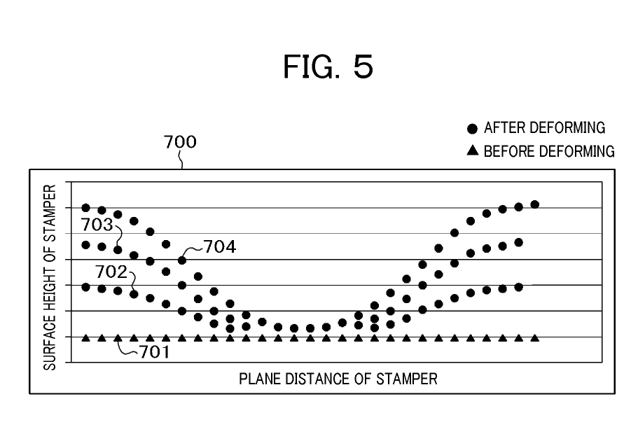

Herein, in FIG. 5 is shown a graph, plotting heights of the surface of the stamper, for showing a curving condition of the stamper within the microstructure transcription apparatus mentioned above. The condition before the deformation is shown by 701, and conditions after the deformation are shown by 702 to 704. Thus, the stamper 100 under the initial condition, which was explained in the above, is in the condition shown by a curved line 701 in the graph. Also, the stamper, an air in the space on the rear surface thereof is discharged into a vacuum, so that an upper surface stamper is suppressed onto the stamper holder portion in the vicinity of the outer peripheral portion thereof; i.e., being deformed (or curved) into a convex-shape, being suppressed by the stamper backup elastic body in the vicinity of a central portion thereof, is in the conditions of 702 to 704. From this fact, it can be seen that the stamper changes or alters, fitting to the condition suitable for the material of the body to be transcribed or for the size thereof.

Following to the above, an upper surface pressing/adhering unit not shown in the figure is driven, to approach a pressure base to the disc substrate, and the stamper 100 mentioned above is suppressed onto the disc substrate, directing from a central portion to a peripheral portion thereof (step S34). The condition of the pressure, etc., within the microstructure transcription apparatus, in this instance, are shown in FIG. 4C attached. Thus, since the stamper 100 is in the spherical shape, having the most suitable curvature, fitting to the condition suitable for the material of the body to be transcribed or for the size thereof, in the steps mentioned above, then that stamper 100 can be suppressed onto the disc substrate, under the condition being preferable much more. And, when the suppressing pressure (i.e., “suppress” in the figure) comes to a predetermined value, movement of the pressure base is stopped (step S35), and further, the discharging to vacuum (i.e., the negative pressure “A” and the pressure “B”) of the rear surface of the stamper 100 is stopped (step S36).

Thereafter, the stamper 100 is suppressed onto the entire surface of the disc substrate (step S37), and is irradiated with an UV light thereon, to expose the resist thereon (step S38). The condition of the pressure, etc., within the microstructure transcription apparatus, in this instance, are shown in FIG. 4D attached.

And, after completing the exposure of the resist, the upper surface pressing/adhering unit is moved back, so as to exfoliate the stamper 100 from the surface of the disc substrate, i.e., the body to be transcribed (step S39). The condition of the pressure, etc., within the microstructure transcription apparatus, in this instance, are shown in FIG. 4E attached. Further, in this instance, the negative pressure “A” is guided into the space defined between the frame member 202 of the stamper holder member 200 and the backup elastic body 204, so as to hold the stamper 100.

With such microstructure transcription apparatus according to the present invention, the details thereof being mentioned in the above, it is possible to alter or change the curvature of the spherical shape on the surface of the stamper, appropriately, fitting to the condition suitable for the material of the body to be transcribed or for the size thereof, most suitably, when conducting the transcription, and thereby to transcribe the micro patterns, without lowering the throughput of an entire, in spite of changing of a model to be manufactured.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A microstructure transcription apparatus for transcribing microscopic concave-convex patterns on a body to be transcribed, comprising:
a stamper, on a surface of which is formed microscopic concave-convex pattern; and
a stamper holder portion, which holds said stamper, wherein
said stamper holder portion comprises a transparent backup member, a stamper backup elastic body, which is attached on said backup portion covering over a central portion thereof, a space, into which a negative pressure is introduced for absorbing said stamper to hold, and a member, which is formed surrounding said stamper holder portion therein and contacts on an outer peripheral portion of said stamper, and further
said contact member is movable with respect to said backup member, and thereby a curvature of a curved surface of said stamper to be suppressed onto said stamper backup elastic body is changeable.

2. The microstructure transcription apparatus, as described in the claim 1, wherein said contact member is movable through pressure, with respect to said backup member.

3. The microstructure transcription apparatus, as described in the claim 2, wherein
said contact member is disposed in a space within an inside of a circular frame member, being formed surrounding said stamper holder portion, in a movable manner, and further comprises a means for introducing pressure into the space defined between said frame member and said contact member.
